(19) United States
(12) Patent Application Publication
(10) Pub. No.: US 2024/0217614 A1
(43) Pub. Date: Jul. 4, 2024

(54) Valves For Changing The Pressure Of A Fluid In A Suspension And Retainer For Retaining Fluid In A Suspension

(71) Applicant: Eko Sport, Inc., Grand Junction, CO (US)

(72) Inventors: Scott S. Winans, Grand Junction, CO (US); Darek C. Barefoot, Grand Junction, CO (US)

(21) Appl. No.: 18/389,981

(22) Filed: Dec. 20, 2023

Related U.S. Application Data
(60) Provisional application No. 63/521,445, filed on Jun. 16, 2023.
(60) Provisional application No. 63/435,717, filed on Dec. 28, 2022.

(51) Int. Cl. B62K 25/06

(52) U.S. Cl. CPC B62K 25/06

(57) ABSTRACT

A suspension system for a fork includes a first tube and a second tube that telescopically interfit with one another. An atmospheric release valve allows a compressible fluid to move from the interior of the first tube to the exterior of the first tube when the pressure of the compressible fluid exceeds a release valve threshold. A fluid introduction valve is spaced from the atmospheric release valve and allows the introduction of a compressible fluid and an incompressible fluid from the exterior of the first tube to the interior of the first tube. A fluid retainer is positioned adjacent the fluid introduction valve to retain the fluid introduced.

### BACKGROUND OF THE INVENTION

The present disclosure relates generally to suspension components on vehicles. More particularly, the present disclosure relates to a shock absorber including one valve that allows a first at least one fluid to move from the inside or interior of a shock absorber to the outside or exterior of the shock absorber and another valve remote from the one valve that allows the introduction of a second at least one fluid from the exterior of the shock absorber to the interior of the shock absorber. The present disclosure also relates to a foam fluid retainer inserted into a shock absorber for retaining oil for lubrication of a seal and other components.

Many shock absorbers include a leg that includes a lower portion that contains a fluid. In many cases, the lower leg may contain both a compressible fluid, such as air, and an incompressible fluid, such as oil. It may be desirable to allow a user to put additional fluid, whether compressible or incompressible, into the leg. In other circumstances, the pressure of the incompressible fluid may become too high and may negatively affect the performance of the shock absorber, and therefore release of the pressure may be desirable.

In some prior art devices, a user may invert the shock absorber and use a Schrader valve or the like to remove or insert additional fluid into the lower leg. Schrader valves are conventionally included near the bottom of the fork to accommodate the desire for a port for fluid ingress and egress, while minimizing the risk of the port becoming damaged by or caught on an obstacle in a trail ride.

In other prior art devices, a single port similar to a Schrader valve may be placed elsewhere on the fork, such as near the top of the lower leg. Such a placement may allow a user to manually insert or release air from the lower leg. However, that configuration requires a user to manually actuate the valve to insert or release fluid from the valve. The placement is often selected to reduce the probability of the incompressible fluid being removed from the fork leg when the valve is actuated. However, such a design does not permit compressible fluid to be conveniently removed when the pressure within the lower fork exceeds a desirable level.

In addition, in many shock absorbers, an upper leg may slide relative to a lower leg, so that on compression, the leg portion with a smaller diameter may slide within the leg portion with a larger diameter. A conventional configuration may include seals, bushings, and other parts that affect the sliding and sealing functions between the leg portions. Over time, friction can increase between these parts as dust or debris make their way past one or more seals, wear or damage from the riding environment is introduced, lubricant introduced during assembly breaks down, or a variety of other factors. In addition, the lubrication may tend to migrate away from this local region under the influence of gravity and also due to lubrication transport via the stanchion surface past the mate areas. This friction can cause the shock absorber parts to resist compression and extension in a manner that negatively affects a rider's experience.

In prior art devices, when additional lubricant is to be added, a user typically inverts the suspension and disassembles the fork or rear shock. Then the parts may be cleaned and additional lubricant added before reassembling the fork. In many cases, this is time consuming and requires substantial attention to detail. If a rider experiences increased friction when away from his or her home shop, this can lead to frustration.

The need therefore exists for a shock absorber that includes a first valve that allows a rider to manually increase the lubricant levels within a shock by introducing fluid from the outside of the shock absorber to the interior of the shock absorber and a second valve remote from the first valve that actuates to release excess pressure within the shock absorber when the pressure exceeds an appropriate threshold, without intervention by the rider. It is further desirable that the shock absorber include a structure that allows at least some of the fluid inserted into the shock absorber to be retained adjacent the seal to allow for additional lubrication of the seal. Such a design may also allow the rider to configure an appropriate pressure level within the shock absorber and to allow for appropriate lubrication of the parts of the shock absorber. Such a configuration may allow a rider to customize their ride to their desires.

### SUMMARY OF THE INVENTION

In one embodiment, a shock absorber includes a first tube, a second tube, and a release valve. The first tube may include an interior and an exterior. The interior of the first tube may at least partially define a first chamber. The first chamber may be at least partially filled with a first at least one fluid. The exterior of the first tube may be exposed to ambient air at atmospheric pressure. The second tube may be configured to telescopically interfit with the first tube. The release valve may be adjacent a first passageway. The release valve may be configured to allow the first at least one fluid to move through a first passageway from the interior of the first tube to the exterior of the first tube when a pressure of the at least one fluid exceeds a release valve threshold. The release valve may include a first spring, a first blocker, a first seat, and a first spring adjuster. The first spring adjuster may be configured to adjust the release valve threshold. The first spring may urge the first blocker against the first seat to block movement of the first at least one fluid through the first passageway.

The first spring adjuster may be adjustable from the exterior of the first tube.

The shock absorber may further include a fluid introduction valve adjacent a second passageway. The fluid introduction valve may be configured to allow a second at least one fluid to move through the second passageway from the exterior of the first tube to the interior of the first tube. The fluid introduction valve may include a second spring, a second blocker, and a second seat. The second spring may urge the second blocker against that second seat. The shock absorber may further include a fluid introduction fixture configured to mate with the fluid introduction valve.

The fluid introduction fixture may include a reservoir. The fluid introduction fixture may include a pump attached to the reservoir. The pump may be a plunger configured to reciprocate within the reservoir and configured to be actuated by a user.

The second at least one fluid may include a substantially incompressible fluid.

The release valve and the fluid introduction valve may be spaced from one another longitudinally along a length of the first tube. The release valve and the fluid introduction valve may be spaced from one another circumferentially about a circumference of the first tube.

In another embodiment, a shock absorber may include a first tube, a second tube, a first valve, and a second valve. The first tube may have an interior and an exterior. The interior of the first tube may at least partially define a first chamber. The first chamber may be at least partially filled with a first at least one fluid. The second tube may be configured to telescopically interfit with the first tube. The first valve may be adjacent a first passageway and may allow the first at least one fluid to move from the interior of the first tube to the exterior of the first tube. The second valve may be adjacent a second passageway and may allow a second at least one fluid to move from the exterior of the first tube to the interior of the first tube. The first passageway may be spaced from the second passageway.

The first valve may include a first spring, a first blocker, a first seat, and a first spring adjuster. The first release valve may be configured to allow the first at least one fluid to move through the first passageway from the interior of the first tube to the exterior of the first tube when a pressure of the first at least one fluid exceeds a first release valve threshold. The first spring adjuster may be configured to adjust the first release valve threshold. The first spring may urge the first blocker against the first seat to block movement of the first at least one fluid through the first passageway.

The first spring adjuster may be adjustable from the exterior of the first tube.

The shock absorber may further include a fluid introduction fixture configured to mate with the second valve. The mating of the fluid introduction fixture to the second valve may move a second blocker away from a second seat. The fluid introduction fixture may further include a reservoir. A plunger may be configured to reciprocate in the reservoir and may be configured to be actuated by a user.

The first passageway may be spaced longitudinally along a length of the first tube from the second passageway. The first passageway may be spaced circumferentially about a circumference of the first tube from the second passageway. The first passageway may be spaced both longitudinally and circumferentially from the second passageway.

In another embodiment, the shock absorber may include a first tube, a second tube, a fluid introduction passageway, a fluid introduction valve, and a fluid retainer. The first tube may have an interior and an exterior. The interior of the first tube may at least partially define a first chamber. The second tube may be configured to telescopically interfit with the first tube. The fluid introduction passageway may extend between an interior port on the interior of the first tube and an exterior port on the exterior of the first tube. The fluid introduction valve may be configured to allow the introduction of at least one fluid through the fluid introduction passageway from the exterior of the first tube to the first chamber. The fluid retainer may be positioned adjacent the interior port. The fluid retainer may be configured to retain at least some of the at least one fluid introduced through the fluid introduction passageway.

The fluid retainer may be a ring. The fluid retainer may be made from a foam. The foam may be an open-celled foam. The foam may be configured to retain at least 1 milliliter of the at least one fluid. The fluid retainer may have a first length and the interior port may have a second length. The first length may be greater than the second length.

The shock absorber may further include a seal. The seal may extend between the first tube and the second tube. The fluid retainer may be positioned adjacent the seal. The shock absorber may further include at least one bushing. The fluid retainer may be between the at least one bushing and the seal. The interior port may be positioned between the seal and the fluid retainer. The interior port may be between the seal and the at least one bushing. The interior port may be between the at least one bushing and the fluid retainer.

The fluid introduction valve may include a spring, a blocker, and a seat. The spring may urge the blocker against the seat.

The shock absorber may further include a fluid introduction fixture. The fluid introduction fixture may include a reservoir and a reservoir passageway. The reservoir may contain at least a portion of the at least one fluid. The reservoir passageway may allow the portion of the at least one fluid to flow from the reservoir to the fluid introduction fixture, through the fluid introduction valve, and into the first chamber. The shock absorber may further include a pump configured to move the portion of the at least one fluid from the exterior of the first tube to the interior of the first tube. The pump may include a plunger configured to reciprocate in the reservoir and configured to be actuated by a user.

The at least one fluid may comprise a substantially incompressible fluid.

### BRIEF DESCRIPTION OF DRAWINGS

FIG. 1 is a perspective view of a bicycle showing the general configuration and position of the shock absorbers according to the disclosed embodiments;

FIG. 2 is an exterior front view of a front fork shock absorber of a bicycle according to the disclosed embodiments;

FIG. 3 is an exterior back view of the front fork of FIG. 2;

FIG. 4 is an exterior back view of the lower leg of the front fork of FIG. 2;

FIG. 5 is a cross-sectional view of the lower leg of FIG. 4, taken along line 5-5 of FIG. 4;

FIG. 6 is a close view of the leg of FIG. 5 within the area shown by the dashed lines 6 in FIG. 5;

FIG. 7 is a close view of an alternative embodiment of the leg of FIG. 5 within the area shown by the dashed lines 6 in FIG. 5;

FIG. 8 is a cross-sectional view of the lower leg of a shock absorber according to the disclosure, taken along line 8-8 of FIG. 4;

FIG. 9 is a close view of the leg of FIG. 8 within the area shown by the dashed lines 9 in FIG. 8;

FIG. 10 is a cross-sectional view of the one leg of the shock absorber of FIG. 2 taken along line 10-10 showing the shock absorber in an extended position with the second tube in a first position;

FIG. 11 is a cross-sectional view of one leg of a shock absorber of FIG. 2 taken along line 10-10 of FIG. 2 showing the shock absorber in a compressed position with the second tube in the second position;

FIG. 12 is a perspective view of a shock absorber according to the disclosure showing an embodiment of a fluid introduction fixture as attached;

FIG. 13 is a side view of the embodiment of FIG. 12;

FIG. 14 is a close portion of a cross-sectional view of the lower leg taken along line 14-14 of FIG. 4;

FIG. 15 is an alternative version to FIG. 14 of a close portion of a cross-sectional view of the lower leg taken along line 14-14 of FIG. 4;

FIG. 16 is a close portion of a cross-sectional view of the lower leg taken along line 14-14 of FIG. 4, showing an embodiment of the retainer;

FIG. 17 is a close portion of a cross-sectional view of the lower leg taken along line 14-14 of FIG. 4, showing another embodiment of the retainer;

FIG. 18 is a close portion of a cross-sectional view of the lower leg taken along line 14-14 of FIG. 4, showing yet another embodiment of the retainer;

FIG. 19 is a perspective view of a rear shock of a bicycle according to another embodiment;

FIG. 20 is a side view of the embodiment of FIG. 19;

FIG. 21 is a cross-sectional view of the embodiment of FIG. 20, taken along line 21-21 showing the shock absorber in an extended position;

FIG. 22 is the same cross-sectional view as FIG. 21, showing the shock absorber in a compressed position.

FIG. 23 is a front view of the embodiment of FIG. 19 showing a fluid introduction fixture;

FIG. 24 is a cross-sectional view of FIG. 23 taken along line 24-24.

In describing the preferred embodiment of the invention which is illustrated in the drawings, specific terminology will be resorted to for the sake of clarity. However, it is not intended that the invention be limited to the specific term so selected, and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

In this detailed description, various terms relating to direction may be used. The elements discussed herein relate to a bicycle. Because, in its operable position, a bicycle is oriented generally vertically, i.e., perpendicular to the ground, the direction terms refer to the position of an element relative to gravity when the bicycle is in its operable position. Accordingly, for example, the term “downwardly” refers to the direction towards the ground when the bicycle is in its operable position, and the term “forwardly” relates to a direction towards a front wheel of the bicycle when it is in its operable position. Further, the terms “inboard” and “outboard” may be used. The term “inboard” describes a position between one item and a vertical plane substantially bisecting the bicycle. The term “outboard” describes a position of an object further from the vertical center plane of the bicycle. In addition, the terms “bicycle” and “bike” are used herein interchangeably. A person having ordinary skill in the art will understand that if something is referred to as one, it can refer to the other.

In the present disclosure, the suspension structure may be described as it relates to a bicycle. However, the suspension structure described in the present embodiments may instead be applied to other vehicles. The present suspension structure may be used with vehicles having a different number of wheels, for example. The suspension structure may be used in connection with a motorized vehicle. In the present disclosure, the terms “fork”, “suspension” and “shock absorber” may be used somewhat interchangeably. A person of ordinary skill in the art is able to understand the nuances between these terms and understand their use interchangeably in the disclosure. The present disclosure describes a suspension system that may be at least partially filled with a compressible gas. In the descriptions herein, it will be understood by a person having ordinary skill in the art that the pressure within the suspension unit at the beginning of a suspension stroke may be substantially in equilibrium throughout the suspension system. A user may select from a variety of pressures within the suspension unit, depending on the user's preferences regarding ride and handling and the demands of a particular course the rider desires to ride. These factors are all well-known in the art and are not described in detail herein.

The structures described herein may be applied to either a front or rear suspension of a vehicle, most particularly a bicycle. The remaining structures present in the suspension may be illustrated and may be described in at least a cursory fashion. However, these structures are not critical to the use of the embodiments described herein. The present embodiments could be incorporated with other suspensions that use a compressible gas. Accordingly, the suspension system elements shown should not be construed as being limiting to the embodiments described.

In general, persons of ordinary skill in the art are familiar with the structural and functional differences and limitations between shock absorbers and can make the necessary modifications to use the structures described herein in context. However, a person of ordinary skill in the art is able to understand that any of the disclosed embodiments could, in theory, be used in another suspension system in current operation or later developed.

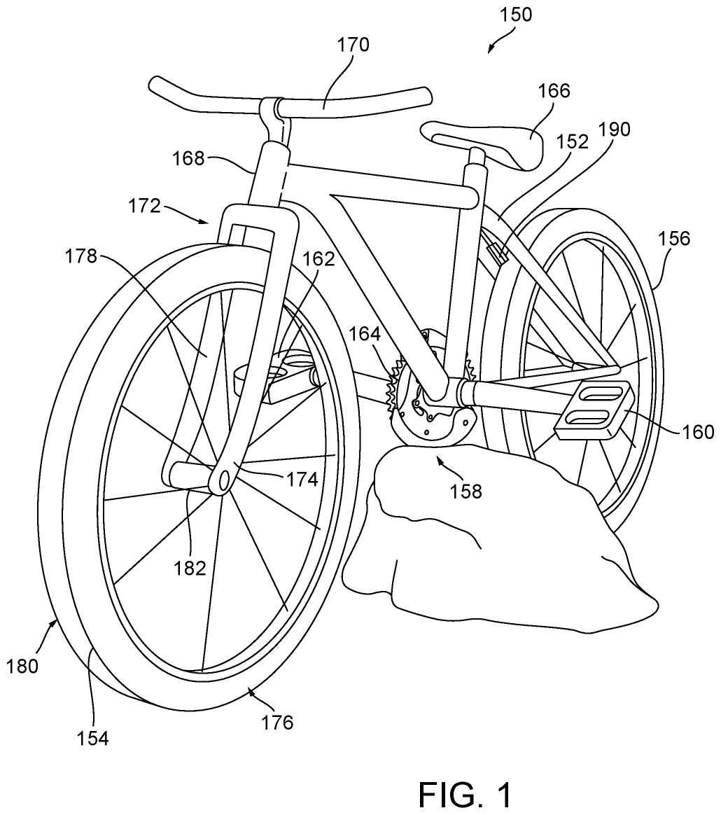

The overall configuration of the present device in the context of a vehicle is shown in FIG. 1. Many of the parts are shown schematically in this FIG., in an overall configuration, rather than illustrating the details of the design. The present shock absorbers are configured to be primarily used with a pedaled bicycle, such as the bicycle 150. The device could be used with a powered bicycle, a motorcycle, a moped, or similar vehicle. The bicycle 150 may include a frame 152, a front wheel 154, and a rear wheel 156. The bicycle 150 may further include a drive system 158 that conventionally includes a first pedal 160 and a second pedal 162 positioned generally opposite one another. When a user uses motive power, the user alternatingly presses the first pedal 160 and the second pedal 162. Each of the first pedal 160 and the second pedal 162 are conventionally attached to a front chain ring 164. A conventional chain (not shown) transmits the driving force from the pedals 160, 162, through the front chain ring 164 to a rear chain ring (not shown). The rear chain ring is secured to the rear wheel 156, causing it to rotate about an axle passing therethrough (not shown) and thereby causing the bicycle 150 to move. The bicycle frame 152 conventionally allows for the attachment of a seat 166 that a user sits on when using the pedals 160 and 162. The bicycle frame 152 also conventionally includes a head 168. The head 168 allows for the attachment of handlebars 170 that further attach through the head 168 to a front fork 172.

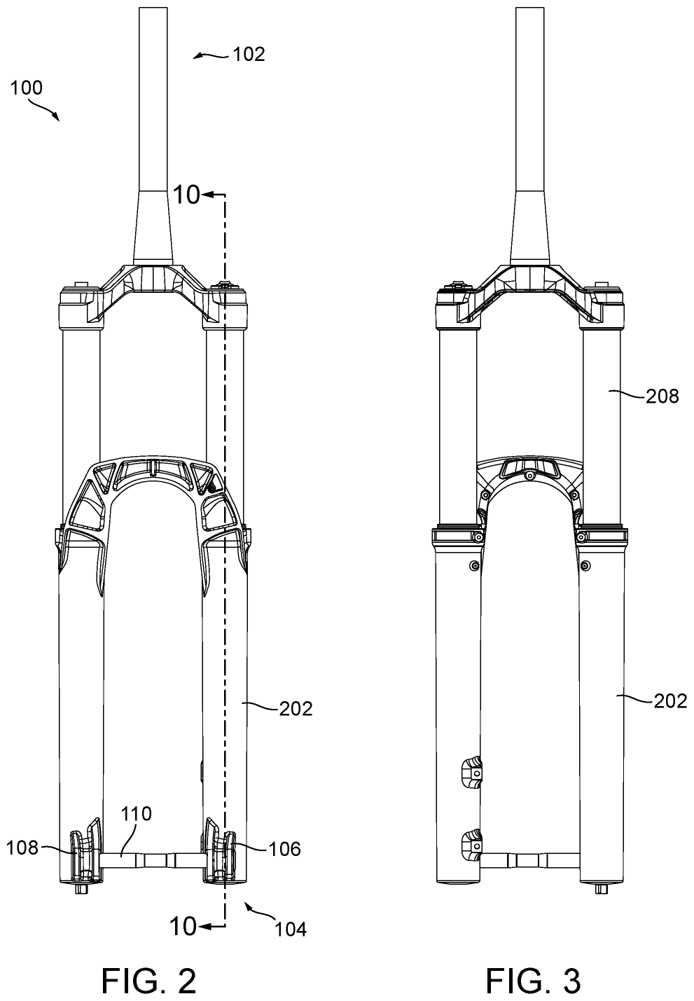

The front fork 172 conventionally has a first leg 174 that extends on one side 176 of the front wheel 154 and a second leg 178 that extends on an opposite side 180 of the front wheel 154. An axle 182 is configured to pass through a center of the front wheel 154 and an aperture in each of the first leg 174 and the second leg 178. Any conventional axle structure and attachment structure can be used with the present suspension system. The following FIGS. illustrate a conventional closed bore system that can be used with any conventional axle that attaches through a closed bore system. In another embodiment, the present disclosed embodiments could incorporate an open bore system, a partially closed bore system, or any other conventional system. FIGS. 2-18 illustrate various embodiments of a shock absorber system that may be used as at least a portion of the front fork 172. A person of ordinary skill in the art may easily make appropriate substitutions of conventional parts to fit one of the illustrated embodiments into the remainder of the bicycle structure.

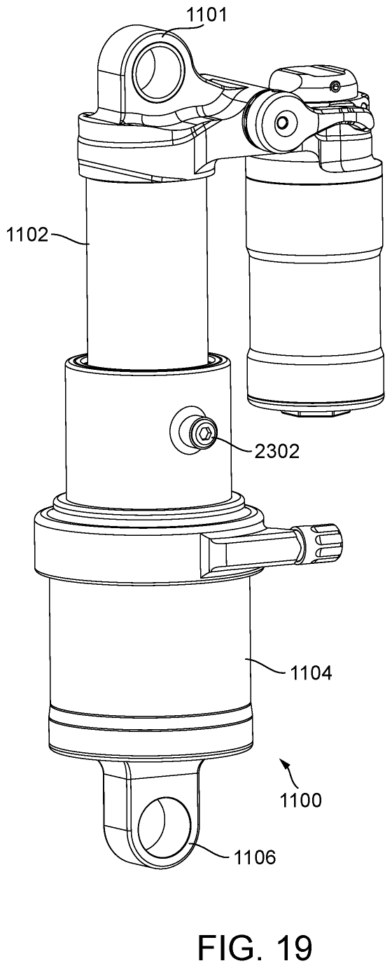

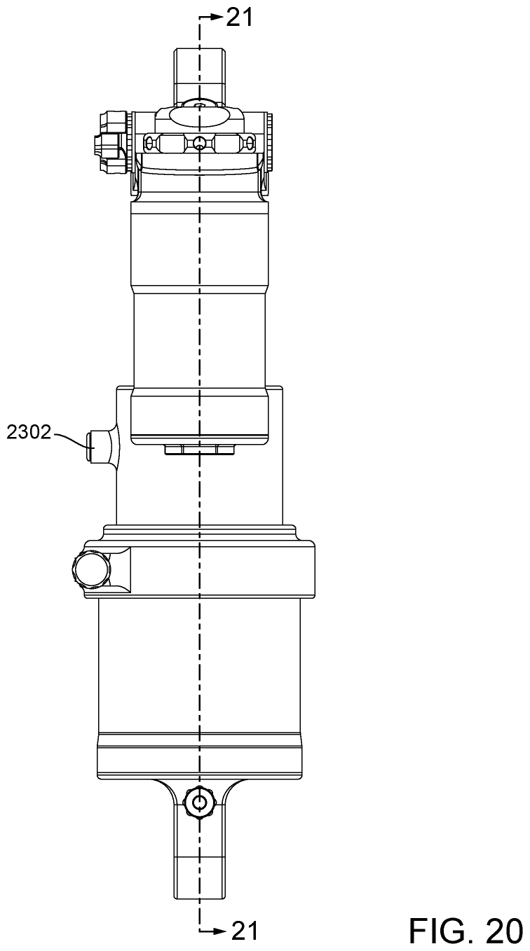

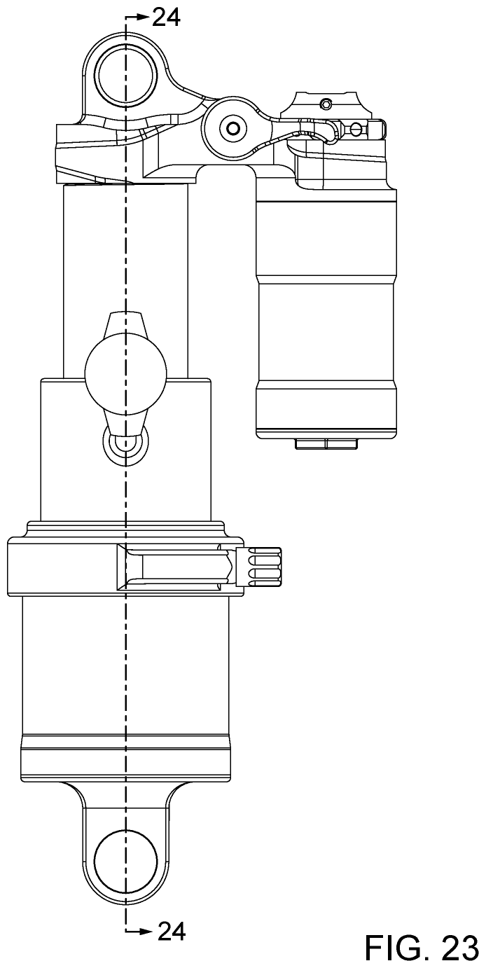

A rear shock 190 may also be incorporated to the bicycle 150. The rear shock 190 may be secured on one end to the frame 152 and on the other end to an appropriate structure that is further secured to the rear wheel 156 to absorb impact force affecting the rear wheel. FIGS. 19-24 illustrate various embodiments of a shock absorber system that may be used as at least a portion of a rear shock 190. A person of ordinary skill in the art may easily make appropriate substitutions of conventional parts to fit one of the illustrated embodiments into the remainder of the bicycle structure.

Turning now to FIGS. 2 and 3, as previously described, the top end 102 of the suspension system 100 may be attached to handlebars or another steering system, manipulable by a rider to set and change the direction of the vehicle. The bottom end 104 of the suspension system 100 may include a first bracket 106 and a second bracket 108 that are configured to allow an axle 110 to be passed therethrough. The first bracket 106 and the second bracket 108 may be any conventional open bore or closed bore bracket as desired by the designer. The axle 110 may include a quick release (not shown). The use of such a quick release is optional and any mechanism for fixing the axle in place may be substituted therefor. In operation, a hub and wheel (not shown) may be mounted in surrounding fashion to the axle 110.

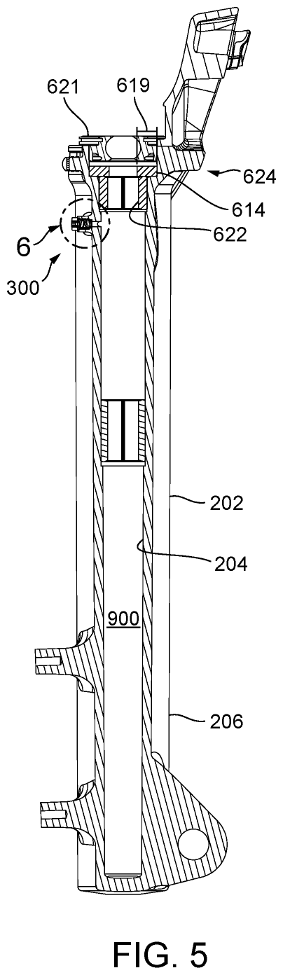

Turning to FIGS. 3-9, an overview of the structure may be seen. In one embodiment, as best seen in FIG. 5, the shock absorber 100 includes a first tube 202 having an interior 204 and an exterior 206, the interior 204 of the first tube 202 at least partially defining a first chamber 900 and wherein the first chamber 900 is at least partially filled with a first at least one fluid (not shown) and the exterior 206 of the first tube 202 is exposed to ambient air at atmospheric pressure. As shown in FIG. 3, the shock absorber 100 may include a second tube 208 configured to telescopically interfit with the first tube 202. The shock absorber 100 may further include a release valve 300 configured to allow the first at least one fluid to move from the interior 204 of the first tube 202 to the exterior 206 of the first tube 202 when a pressure of the first at least one fluid exceeds a release valve threshold.

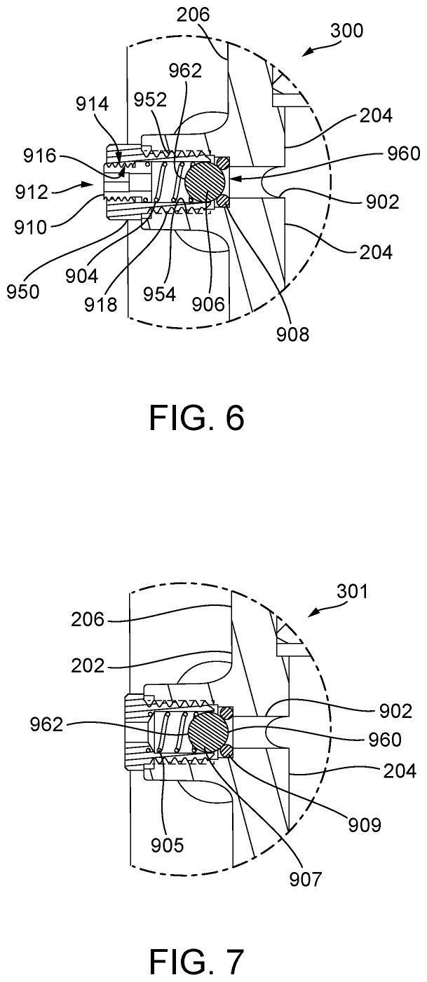

Turning to FIG. 6, the release valve 300 may be positioned adjacent to a first passageway 902 that extends between the interior 204 of the first tube 202 and the exterior 206 of the first tube 202. The release valve 300 may include a first spring 904, a first blocker 906, and a first seat 908, wherein the first spring 904 may urge the first blocker 906 against the first seat 908 to block movement of the first at least one fluid from the interior 204 of the first tube 202 to the exterior 206 of the first tube 202. The shock absorber 100 may also include a first spring adjuster 910 capable of adjusting a release valve threshold. Desirably, the release valve 300 is configured to be a one-way valve that allows passage of fluid from the interior 204 of the first tube 202 to the exterior 206 of the first tube 202.

The release valve threshold may define the pressure or force at which the force of the first spring 904 may be overcome, thereby allowing the first blocker 906 to be moved away from the first seat 908 to allow passage of the at least one fluid from the interior 204 of the first tube 202 to the exterior 206 of the first tube 202. In this way, once a release valve threshold is set, either by the manufacturer or the user, the release valve may in some embodiments be considered to be “automatic.” That is, when the interior pressure within the first chamber 900 exceeds the release valve threshold, the release valve is configured to actuate without the manual intervention of a user to release pressure or force from the interior 204 of the first tube 202 to the exterior 206 of the first tube 202.

In the embodiment shown in FIG. 6, the release valve 300 is shown as being a standard ball-type valve. A person of ordinary skill in the art will be able to select any appropriate conventional valve that may be appropriate in a specific application and can easily make the substitution of another type of valve.

The first spring adjuster 910 may be adjustable from the exterior 206 of the first tube 202. The first spring adjuster 910 may be configured to have an opening 912 configured with a conventional hex shape. An exterior surface 914 of the first spring adjuster 910 may be threaded and may be configured to engage corresponding threads 916 on a portion of an interior surface 918 of an insert 950. The rotation of the first spring adjuster 910 may change the effective length of the first spring 904, thereby changing the pressure necessary to open the release valve 300, which is the release valve threshold. The hex shape of the opening 912 may allow a user to change the length of the first spring 904 by inserting a standard hex wrench (not shown) into the opening 912 and rotating the adjuster 910. A user can select an appropriate opening force or release valve threshold that the user believes to be desirable for a particular riding location and condition. In the illustrated embodiment of FIG. 6, the insert 950 may include threads 952 that may be configured to engage threads 954 on the lower leg 202 to secure the release valve 300 to the lower leg 202.

It is optional to allow a user to adjust the release valve threshold. Instead, the release valve threshold may be set by a manufacturer at an appropriate level. A non-adjustable version of the release valve 301 is shown in FIG. 7. As shown in FIG. 7, the release valve 301 may be positioned adjacent to the first passageway 902. The release valve 301 may include a first spring 905, a first blocker 907, and a first seat 909, wherein the first spring 905 urges the first blocker 907 against the first seat 909 to block movement of the first at least one fluid from the interior 204 of the first tube 202 to the exterior 206 of the first tube 202. In the embodiment shown in FIG. 7, the release valve 301 is shown as being a standard ball-type valve. A person of ordinary skill in the art will be able to select any appropriate conventional valve that may be appropriate in a specific application and can easily make the substitution of another type of valve. A user can select an appropriate opening force or release valve threshold that the user believes to be desirable for a particular riding location and condition.

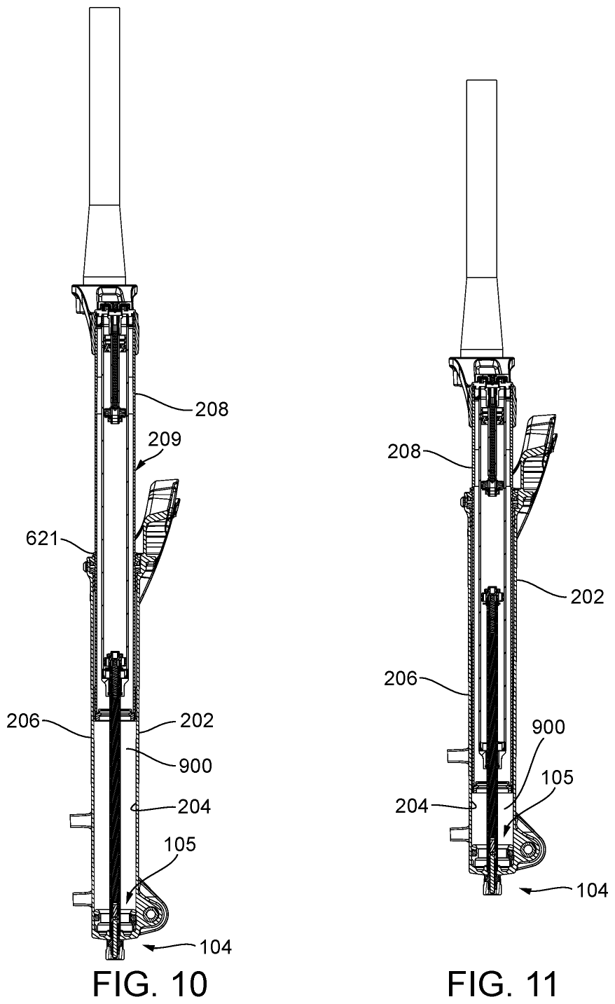

Referring now to FIGS. 10 and 11, the first at least one fluid in the first chamber 900 has a first pressure when in equilibrium. The general extended, equilibrium position is shown in FIG. 10. During a compression stroke, as the second tube 208 telescopically enters the first tube 202, the effective volume of the first chamber 900 decreases, thereby increasing the pressure of the first at least one fluid in the first chamber 900. When the force applied by the pressure of the first at least one fluid in the first chamber 900 on a first side 960 of the blocker 906 or 907 exceeds the force of the first spring 904 or 905 on the second side 962 of the first blocker 906 or 907, the force of the first at least one fluid will overcome the spring force and allow the first blocker 906 or 907 to move away from the first seat 908 or 909, thereby allowing the first at least one fluid to go through the first passage 902 and exit to atmosphere on the exterior 206 of the first tube 202. When the force from the first at least one fluid on the interior 204 of the first tube 202 decreases, the spring force from the first spring 904 or 905 against the second side 962 may push the first blocker 906 or 907 against the first seat 908 or 909 and substantially prevent additional amounts of the first at least one fluid from moving out of the first tube 202. An effective increase in pressure or force within the first chamber 900 may occur in other contexts, such as when additional fluid is added to the suspension as will be described in greater detail below, through adjusting other features of the suspension, as are well known to persons of ordinary skill in the art, or other environmental factors.

In many embodiments, the first at least one fluid within the first chamber 900 may be exclusively or primarily a compressible fluid. However, in many embodiments, an amount of an incompressible fluid may be present within the first chamber 900. The position, shape, size, and other physical properties of the release valve 300 or 301 may be selected to minimize the release of the incompressible fluid through the first passageway 902. In many embodiments, the density of the incompressible fluid may be greater than the density of the compressible fluid, and accordingly, the incompressible fluid may tend to be closer to the bottom end 104 of the suspension system and a corresponding bottom end 105 within the first chamber 900 because of gravity or other factors. However, some of the incompressible fluid may exit the suspension 100 through the first passageway 902 when the release valve 300 or 301 opens. Accordingly, the first at least one fluid that moves through the first passageway 902 may be a first mixture of a compressible fluid and an incompressible fluid. In many embodiments, the compressible fluid may be a gas, such as air or nitrogen, and the incompressible fluid may be a lubricating oil. The precise mixture comprising the first at least one fluid may vary between openings of the release valve as the relative concentration of fluids within the first chamber 900 varies over time.

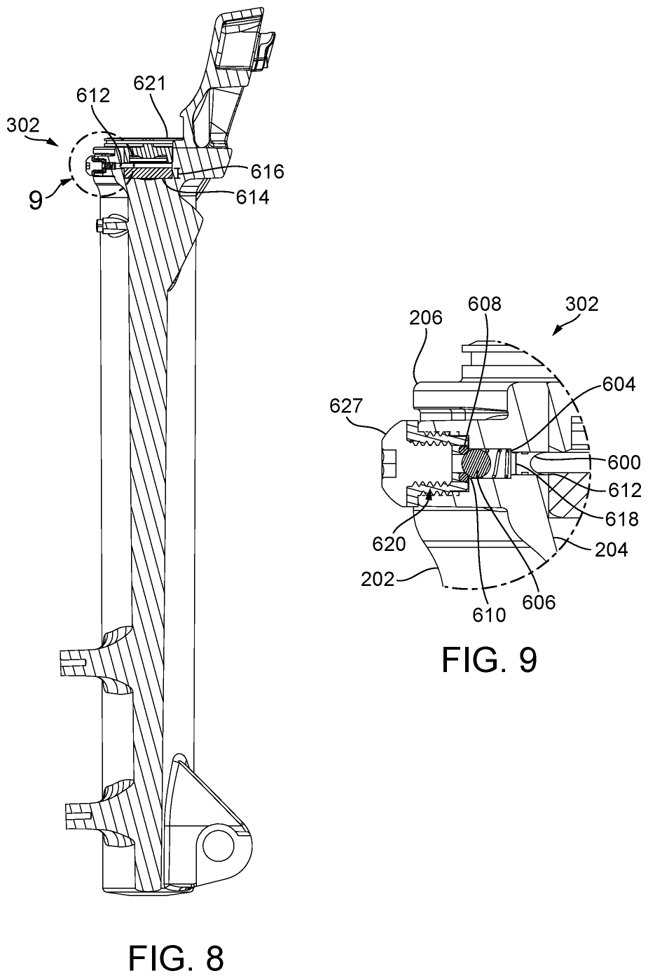

As may best be seen in FIGS. 8 and 9, the shock absorber 100 may further include a fluid introduction valve 302 configured to allow a second at least one fluid to move from the exterior 206 of the first tube 202 to the interior 204 of the first tube 202. Desirably, the fluid introduction valve 302 is configured to be a one-way valve that allows passage of fluid from the exterior 206 of the first tube 202 to the interior 204 of the first tube 202. The fluid introduction valve 302 may be positioned adjacent a second passageway 600 that extends between an exterior port 610 on the exterior 206 of the first tube and an interior port 612 on the interior 204 of the first tube 202. The fluid introduction valve 302 may also include a second spring 604, a second blocker 606, and a second seat 608, wherein the second spring 604 urges the second blocker 606 against the second seat 608 to substantially block movement of the second at least one fluid from the exterior 206 of the first tube 202 to the interior 204 of the first tube 202. In some embodiments, the exterior configuration 620 may be configured to allow the insertion of a plug, such as the plug 627. The plug 627 may be configured to be removably positioned adjacent the exterior port 610 to substantially restrict access to the exterior port 610 and thereby substantially block the insertion of the second at least one fluid through the fluid introduction valve 302 when the plug 627 is inserted.

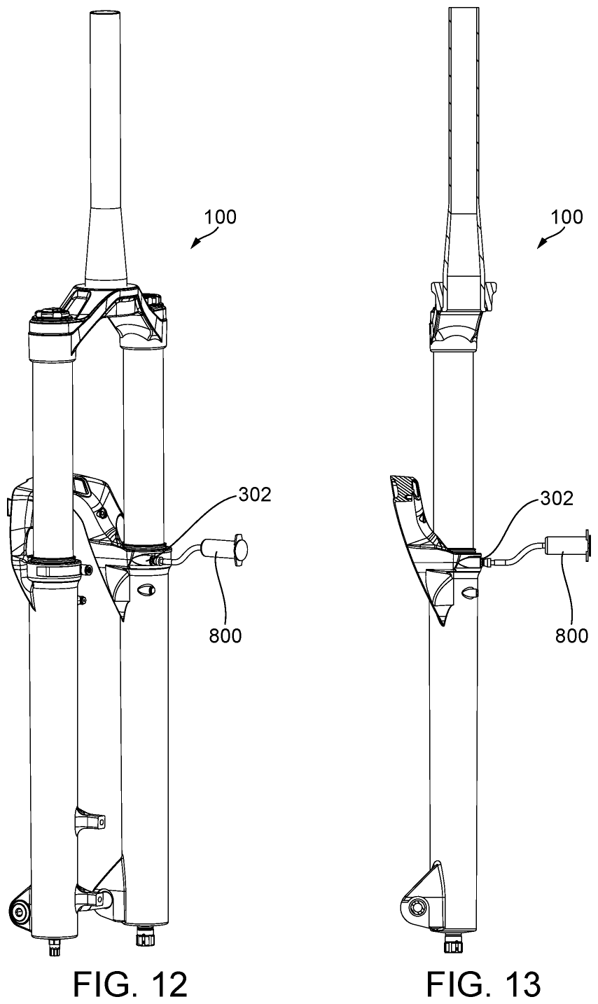

As shown in FIGS. 12 and 13, the shock absorber 100 may further include a fluid introduction fixture 800 configured to mate with the fluid introduction valve 302. The mating of the fluid introduction fixture 800 to the fluid introduction valve 302 may allow the introduction of the second at least one fluid from the exterior 206 of the first tube 202 to the interior 204 of the first tube 202. The fluid introduction valve threshold at which the second at least one fluid may be introduced into the interior 204 of the first tube 202 may desirably be set to be relatively high. In general, it is desirable for the fluid introduction valve 302 to only actuate when a user desires to manually insert fluid into the first chamber 900. If the fluid introduction valve release threshold is set too low, the fluid introduction valve 302 could undesirably actuate in a more automatic manner. A person of ordinary skill in the art will be able to select an appropriate fluid introduction valve release threshold that is low enough to allow the fluid introduction valve 302 to be opened only at an appropriate time and only in an appropriate manner.

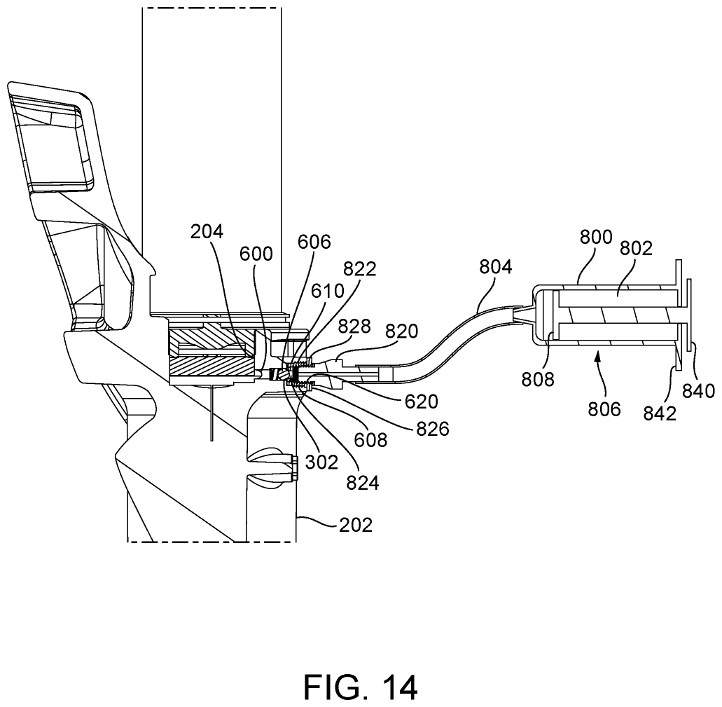

Turning to FIG. 14, the configuration of one embodiment of the fluid introduction fixture 800 may be seen. The fluid introduction fixture 800 may include a reservoir 802 containing at least a portion of the second at least one fluid, and a reservoir passageway 804 allowing the second at least one fluid to flow from the reservoir 802 to the fluid introduction mating member 820, through the fluid introduction valve 302, through the second passageway 600, into the interior 204 of the first tube 202 and into the first chamber 900. The fluid introduction fixture 800 may further include a pump 806 configured to move the second at least one fluid from the exterior 206 of the first tube 202 to the interior 204 of the first tube 202. The pump 806 may include a plunger 808 configured to reciprocate in the reservoir 802 and configured to be actuated by a user.

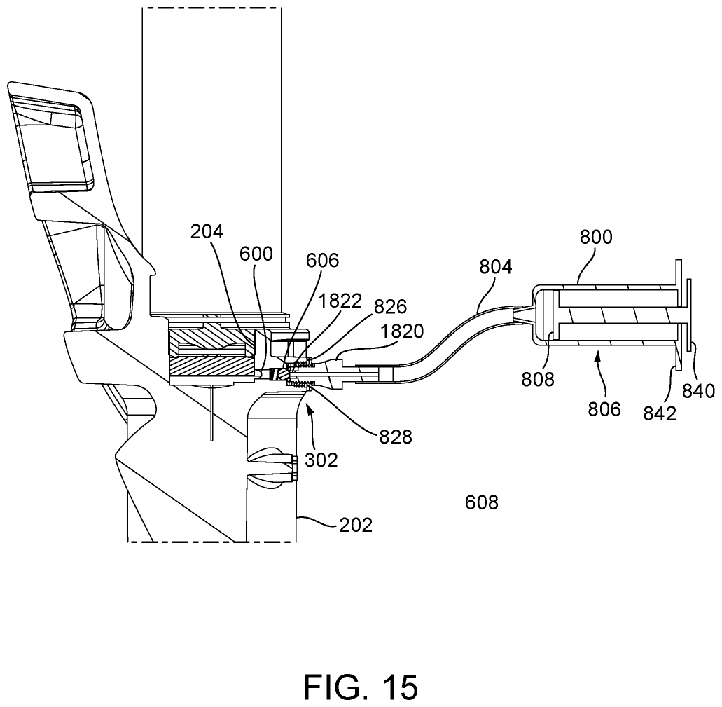

In some embodiments, the mating member 820 may be configured to mate with the exterior profile 620 of the fluid introduction valve 302. In some embodiments, the mating member 820 may include threads 826 that mate with threads 828 on the exterior profile 620 and allow the mating member 820 to be removably threadably engaged with the exterior profile 620. In another embodiment, the mating member 820 may be made of a material configured to seal the mating member 820 to the fluid introduction valve 302. In the embodiment shown in FIG. 14, there may be a gap 824 between the tip 822 of the mating member 820 and the exterior port 610 of the fluid introduction valve 302. In an alternative embodiment shown in FIG. 15, the tip 1822 of the mating member 1820 may be configured to make contact with and dislodge the second blocker 606 from the second seat 608 by overcoming the spring force applied by the second spring 604. In such a configuration, the gap 824 may only be present as the mating member 1820 is being inserted into the exterior profile 620 and the tip 1822 of the mating member 1820 contacts the second blocker 606. The embodiment shown in FIG. 15 is otherwise identical to the embodiment shown in FIG. 14.

In accordance with the embodiment of FIG. 14, when a user desires to add a second at least one fluid into the first chamber 900, the user may insert the mating member 820 into the exterior profile 620. In an embodiment with mating threads 826 and 828, the mating member 820 may be rotated to engage the mating member 820 and the exterior profile 620. The user may then actuate the pump 806. In the manual configuration shown in FIG. 14, the user may press the button 840 towards the flange 842, thereby moving the plunger 808 through the reservoir 802 to the position shown in FIG. 14. The fluid in the reservoir 802 will then be forced from the reservoir 802, through the reservoir passageway 804, and through the mating member 820 into the gap 824. The pressure of the fluid may dislodge the second blocker 606 from the second seat 608 and thereby allow the second at least one fluid to pass through the passageway 600 to the interior 204 of the first tube 202 and into the first chamber 900.

When the configuration of FIG. 15 is used instead, when a user desires to add a second at least one fluid into the first chamber 900, the user may insert the mating member 1820 into the exterior profile 620. In an embodiment with mating threads 826 and 828, the mating member 1820 may be rotated to engage the mating member 1820 and the exterior profile 620. This movement thereby dislodges the second blocker 606 from the second seat 608 by manually overcoming the spring force of the second spring 604. The user may then actuate the pump 806. In the manual configuration shown in FIG. 15, the user may press the button 840 towards the flange 842, thereby moving the plunger 808 through the reservoir 802 to the position shown in FIG. 15. The fluid in the reservoir 802 will then be forced from the reservoir 802, and through the reservoir passageway 804, and through the mating member 1820. The pressure of the fluid may dislodge the second blocker 606 from the tip 1822 of the mating member 1820 and thereby allow the second at least one fluid to pass through the passageway 600 to the interior 204 of the first tube 202 and into the first chamber 900.

The second at least one fluid may be a compressible fluid, a substantially incompressible fluid, or a compressible fluid and a substantially incompressible fluid. In many embodiments, the use of a substantially incompressible fluid or a mixture of a substantially incompressible fluid and a compressible fluid is desirable. In particular the use of an oil or other lubricant may be desirable to provide additional lubrication to the system. In many embodiments, a user may fill the reservoir 802 with a substantially incompressible fluid, such as oil. The reservoir passageway 804 and the mating member 820 or 1820 may be filled with air or another compressible fluid. The gap 824 between the tip 1822 of the mating member and the exterior port 610 may also be filled with air or another compressible fluid. Therefore, when the user actuates the pump 806, a second at least one fluid will be inserted through the second passageway 600 into the first chamber 900. This second at least one fluid is desirably primarily an incompressible fluid. However, the second at least one fluid is likely to include some amount of a compressible fluid from other features in the fluid insertion fixture and system. In most embodiments, the fluid insertion fixture 800 and exterior configuration 620 may be designed to minimize the insertion of compressible fluid. However, the insertion of a compressible fluid need not be eliminated.

In many embodiments, it may be desirable to include a fluid retainer to retain some of the second at least one fluid inserted through the fluid introduction valve 302 adjacent the passageway 600. An overall configuration and position of an embodiment of a fluid retainer may be seen in FIGS. 5 and 8. A fluid retainer 614 may be positioned adjacent the interior port 612. The fluid retainer 614 may be a ring. The fluid retainer 614 may be made of a foam. In some embodiments, the fluid retainer 614 may be made of an open-celled foam. In some embodiments, the fluid retainer 614 may be made of a material, shape, and size to retain at least 1 ml of the second at least one fluid inserted through the fluid introduction valve 302. In other embodiments, the fluid retainer 614 may be felt, or other low density and high porosity foams, plastics, sponges, or other organic materials.

In some embodiments, the fluid retainer 614 may have a first length 616. The interior port 612 may have a second length 618. In some embodiments, the first length 616 is greater than the second length 618. The fluid retainer 614 may be configured to have a thickness 619 that is substantially coextensive with the conventional gap between the interior surface 204 of the first tube 206 and the exterior surface 209 of the second tube 208 (see also FIG. 10). This conventional gap is conventionally between about 4 mm and about 8 mm.

The fluid retainer 614 may be positioned in a variety of positions relative to the other parts of the shock absorber 100. In many embodiments, a seal 621 may be inserted into the free end 624 of the first tube 206. The seal 621 may be configured to extend between the first tube 206 and the second tube 208 (see FIG. 10). In many embodiments, the fluid retainer 614 may be positioned adjacent the seal 621. The shock absorber may also include a bushing 622 that fits on the interior surface 204 of the first tube 206. In many embodiments, the fluid retainer 614 may be positioned between the bushing 622 and the seal 621.

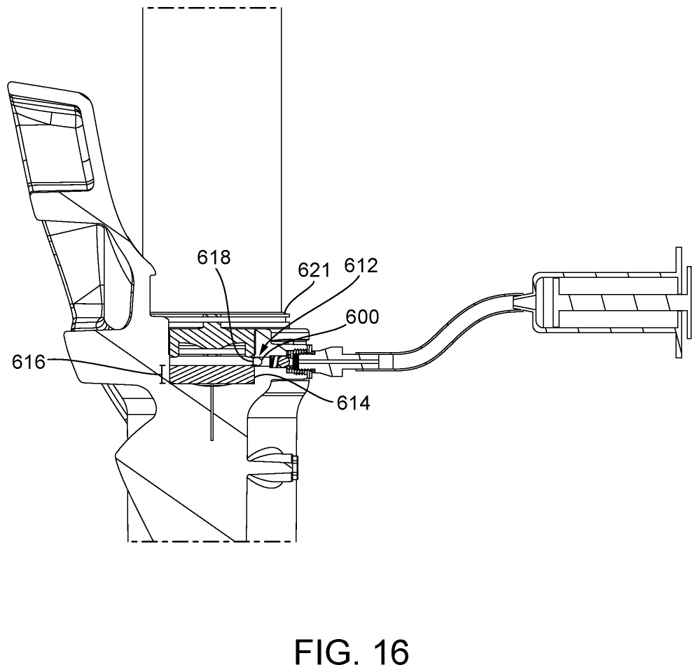

FIGS. 16-18 illustrate various configurations of the arrangement of a fluid retainer which may be used adjacent the interior port 612 of the second passageway 600. Each configuration of the fluid retainer may be selected separately from the configuration of the exterior profile 620, exterior port 610, and fluid insertion valve 302 as described above. Accordingly, while a particular fluid insertion port and fixture and fluid insertion valve may be illustrated in each of FIGS. 16-18, the other embodiments may be substituted therefor by a person of ordinary skill in the art.

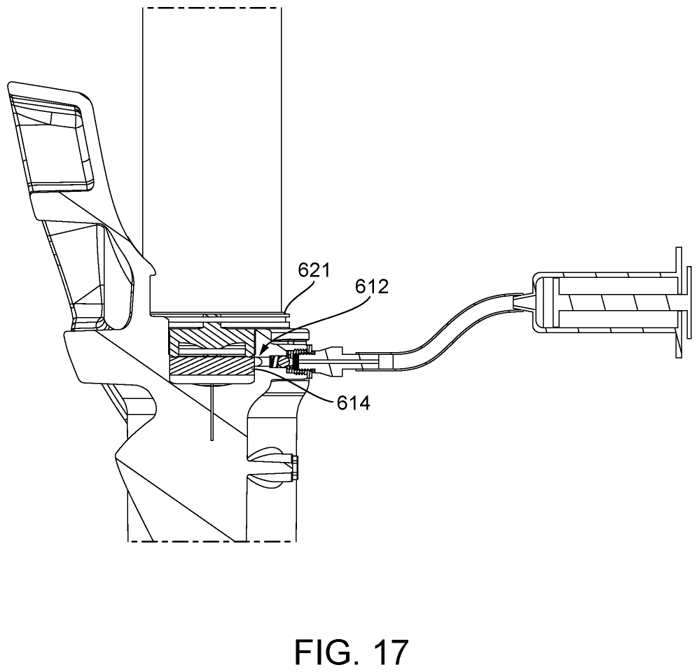

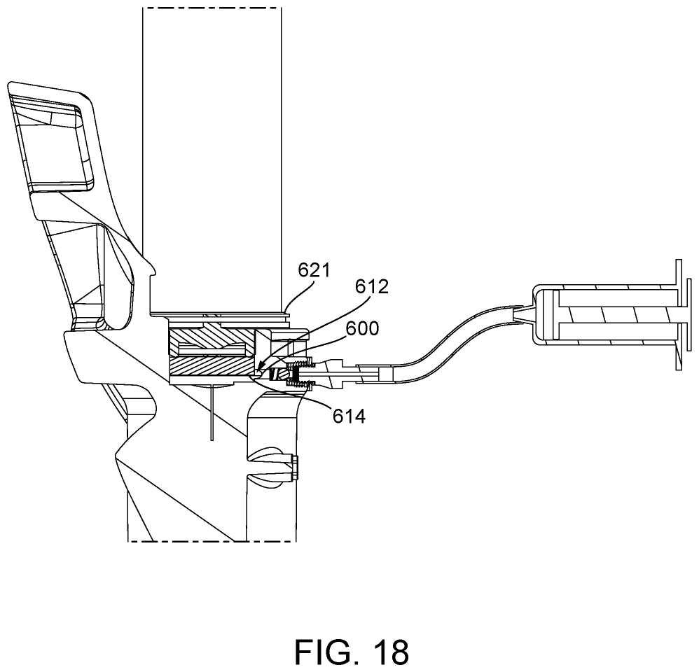

In the embodiment illustrated in FIG. 16, the interior port 612 may be positioned between the seal 621 and the fluid retainer 614. In another embodiment shown in FIG. 17, the interior port 612 may be positioned in the same vertical position as the fluid retainer 614. In another embodiment shown in FIG. 18, the fluid retainer 614 may be positioned at least partially between the interior port 612 and the seal 621. In each illustrated embodiment, the bushing 622 is not shown, but is positioned vertically so that the fluid retainer 614 is positioned between the seal 621 and the bushing 622, as illustrated in FIG. 5.

In many embodiments, the relative position and size of the interior port 612 and the fluid retainer 614 are selected based on the material from which the fluid retainer 614 is selected and the incompressible fluid that is to be inserted through the second passageway. In some embodiments, it is desirable to select a fluid retainer 614 that is capable of retaining at least about 1 ml of the incompressible fluid. The retention of the incompressible fluid by the fluid retainer 614 may be desirable so that the fluid retainer 614 provides an internal reservoir of lubricant in the form of the incompressible fluid. The position of the fluid retainer 614 may allow for the lubricant to be continuously deposited onto the exterior surface 209 of the upper leg 208 and allow for the legs to more easily and smoothly telescope relative to one another.

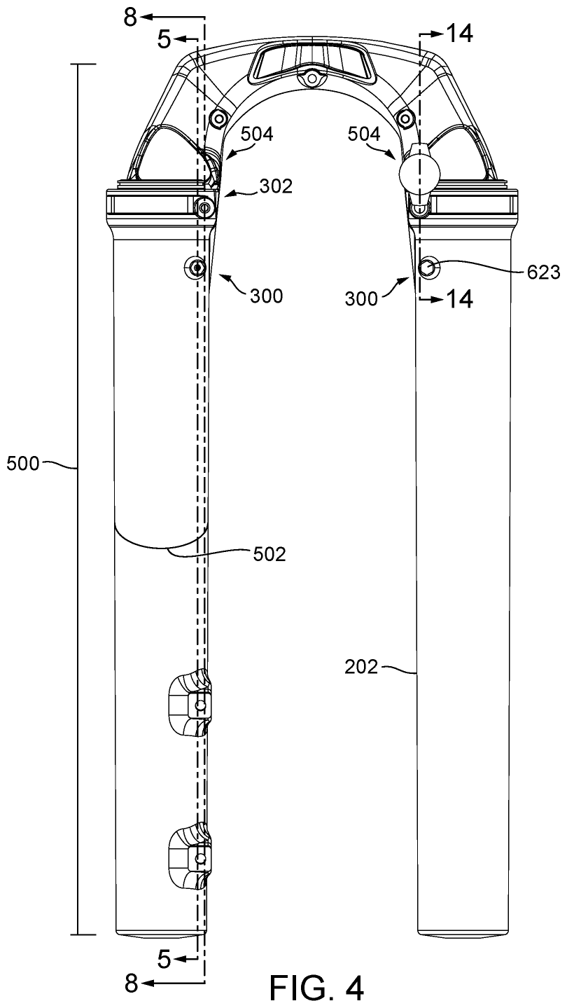

The relative position of the release valve 300 and the fluid introduction valve 302 may best be seen in FIG. 4. The release valve 300 and the fluid introduction valve 302 may be spaced from one another longitudinally along a length 500 of the first tube 202, circumferentially about a circumference 502 of the first tube 202, or both. As may be also seen in FIG. 4, in some embodiments, each leg of the shock absorber 100 may include a release valve 300 and a fluid introduction valve 302. In the embodiment shown, the corresponding valves are positioned to be mirror images of one another. In another embodiment, the corresponding valves may be positioned in different positions. In many embodiments, it may be desirable for the fluid introduction valve 302 to be closer to an open end 504 of the first tube 202 than the release valve 300. In other embodiments, the position of the valves could be switched. A person having ordinary skill in the art can position each of the valves 300, 302 in a position that is most desirable based on the other features that may be attached to the bicycle, wheel, or suspension in a particular configuration. The exact position of the valves, while shown in the same position in each embodiment illustrated, is not limited to the illustrated position.

The shock absorber may further include a first barrier between the exterior of the first tube and the first blocker limiting access to the first blocker from the exterior of the first tube. Such a blocker is shown as blocker 623 in FIG. 4. The shock absorber may further include a second barrier between the exterior of the first tube and the second blocker limiting access to the second blocker from the exterior of the first tube. The first barrier and the second barrier may be configured like the blocker 627 shown in FIG. 9.

Turning to FIGS. 19-24, the suspension system 1100 configured to be used with a rear wheel 156 is illustrated. As previously described, the top end 1102 of the suspension system 1100 may include a first bracket 1101 configured to be attached to the frame 152. The bottom end 1104 of the suspension system 1100 may include a second bracket 1106 that is configured to be attached to a component that moves with the rear wheel 156. Alternatively, the first bracket 1101 of the suspension system 1100 may be configured to be attached to the rear wheel 156 and the second bracket 1106 may be configured to be attached to the frame 152.

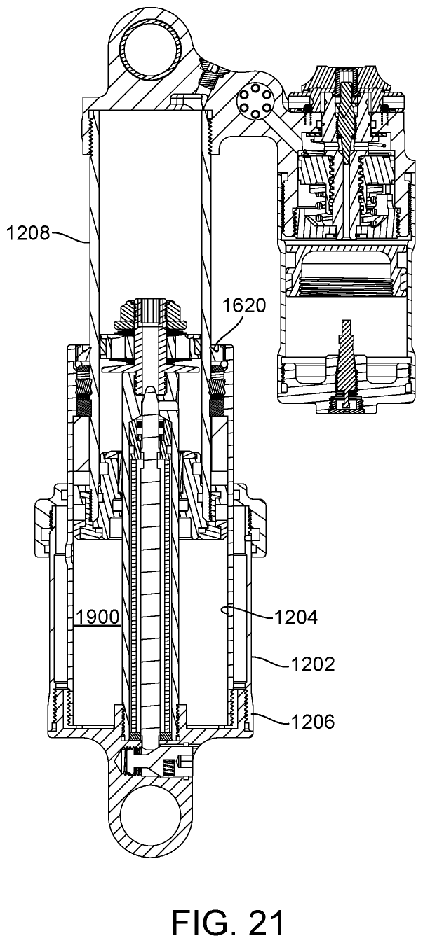

In the illustrated embodiment, and as seen most clearly in FIG. 21, the shock absorber 1100 may include a first tube 1202 having an interior 1204 and an exterior 1206, the interior 1204 of the first tube 1202 at least partially defining a first chamber 1900 and wherein the first chamber 1900 is at least partially filled with at least one fluid (not shown) and the exterior 1206 of the first tube 1202 being exposed to ambient air at atmospheric pressure. The shock absorber 1100 also includes a second tube 1208 configured to telescopically interfit with the first tube 1202.

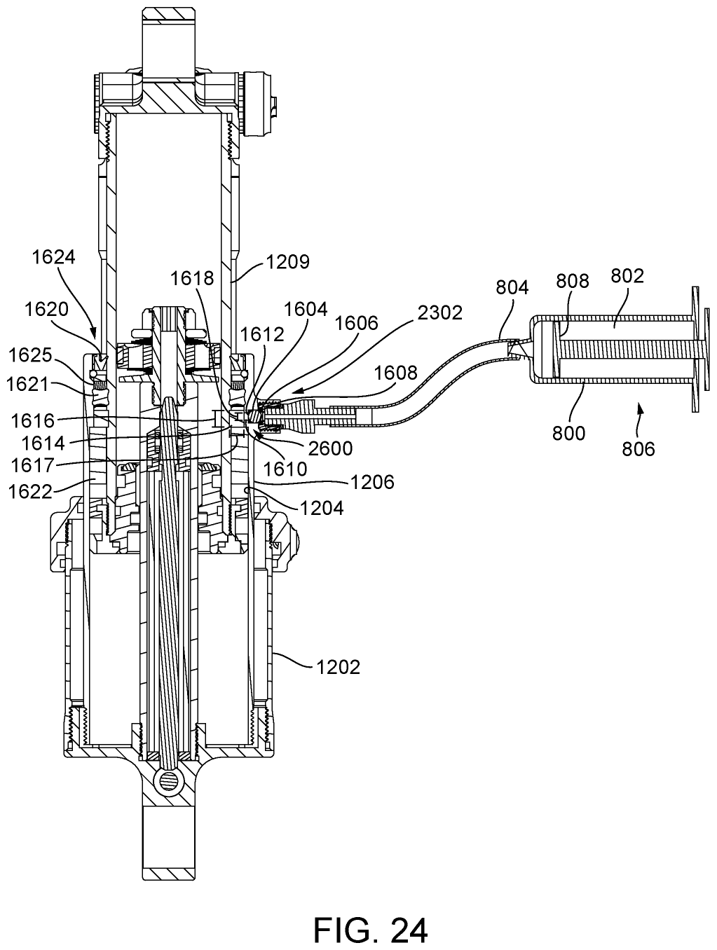

As seen most clearly in FIG. 24, the shock absorber 1100 may further include a fluid introduction valve 2302 configured to allow the at least one fluid to move from the exterior 1206 of the first tube 1202 to the interior 1204 of the first tube 1202. The fluid introduction valve 2302 may include a passageway 2600 that extends between an exterior port 1610 on the exterior 1206 of the first tube and an interior port 1612 on the interior 1204 of the first tube 1202. The fluid introduction valve 2302 may also include a spring 1604, a blocker 1606, and a seat 1608, wherein the spring 1604 urges the blocker 1606 against the seat 1608 to substantially block movement of the at least one fluid from the exterior 1206 of the first tube 1202 to the interior 1204 of the first tube 1202.

A fluid retainer 1614 may be positioned adjacent the interior port 1612. The fluid retainer 1614 may be a ring as shown in FIG. 24. The fluid retainer 1614 may be made of a foam. In some embodiments, the fluid retainer 1614 may be made of an open-celled foam. In some embodiments, the fluid retainer 1614 may be made of a material, shape, and size to retain at least 1 ml of the second at least one fluid. In other embodiments, the fluid retainer 1614 may be felt, or other low density and high porosity foams, plastics, sponges, or other organic materials.

In some embodiments, the fluid retainer 1614 may have a first length 1616. The interior port 1612 may have a second length 1618. In some embodiments, the first length 1616 is greater than the second length 1618. The fluid retainer 1614 may be configured to have a thickness 1617 that is substantially coextensive with the conventional gap between the interior surface 1204 of the first tube 1202 and the exterior surface 1209 of the second tube 1208. This conventional gap is conventionally between about 4 mm and about 8 mm.

The fluid retainer 1614 may be positioned in a variety of positions relative to the other parts of the shock absorber. In many embodiments, a seal 1620 may be inserted into the free end 1624 of the first tube 1206. In many embodiments, a second seal 1621 may also be incorporated. The seal 1620 may be configured to extend between the first tube 1206 and the second tube 1208. In many embodiments, the fluid retainer 1614 may be positioned adjacent the seal 1620. The shock absorber may also include a first bushing 1622 and a second bushing 1625 that each fit on the interior surface 1204 of the first tube 1206. In many embodiments, the fluid retainer 1614 may be positioned between the bushing 1622 and the seal 1620.

In the embodiment illustrated in FIG. 24, the interior port 1612 may be positioned between the seal 1620 and the first bushing 1622. More particularly, the interior port 1612 may be positioned in the same vertical position as the fluid retainer 1614. In another embodiment (not shown), the interior port 1612 may be positioned between the seal 1620 and the fluid retainer 1614 and the interior port 1612 may also be positioned between the seal 1620 and the first bushing 1622. In another embodiment (not shown), the interior port 1612 may be positioned at least partially between the fluid retainer 1614 and the first bushing 1622. In another embodiment (not shown), the interior port 1612 may be positioned at least partially between the fluid retainer 1614 and the second bushing 1624.

The shock absorber 1100 may further include a fluid introduction fixture 800 configured to mate with the one-way fluid introduction valve 2302. The mating of the fluid introduction fixture 800 to the one-way fluid introduction valve 2302 may move the blocker 1606 away from the seat 1608 to allow the introduction of the at least one fluid from the exterior 1206 of the first tube 1202 to the interior 1204 of the first tube 1202. The fluid introduction fixture 800 may further include a reservoir 802 containing the at least one fluid, and a reservoir passageway 804 allowing the at least one fluid to flow from the reservoir to the fluid introduction fixture 800, through the fluid introduction valve 1302 and into the interior 1204 of the first tube 1202. The fluid introduction fixture 800 may further include a pump 806 configured to move the at least one fluid from the exterior 1206 of the first tube 1202 to the interior 1204 of the first tube 1202. The pump 806 may include a plunger 808 configured to reciprocate in the reservoir 802 and configured to be actuated by a user. The at least one fluid may be a compressible fluid, a substantially incompressible fluid, or a compressible fluid and a substantially incompressible fluid. In many embodiments, the use of a substantially incompressible fluid or a mixture of a substantially incompressible fluid and a compressible fluid is desirable, and in particular the use of an oil, may be desirable to provide additional lubrication to the system through the retention of the oil in the fluid retainer 1614. In some embodiments, the one-way fluid introduction valve 2302 may be fitted with an optional plug like the optional plug 627, shown most clearly in FIG. 9, which may protect the fluid introduction valve 2302 when it is not in use.

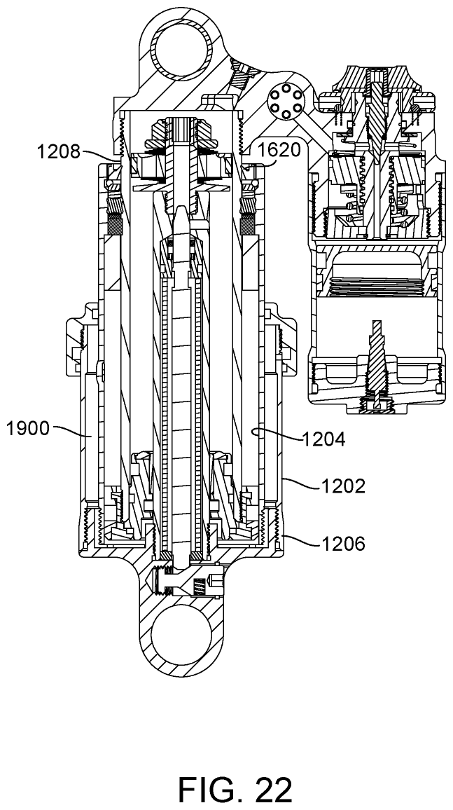

The second tube 1208 may be configured to reciprocate within the first tube 1202 between a first position (shown most clearly in FIG. 21) and a second position (shown most clearly in FIG. 22). The first chamber 1900 may be smaller when the second tube 1208 is in the second position than when the second tube 1208 is in the first position. The pressure from the at least one fluid may increase as the second tube 1208 moves from the first position to the second position.

This detailed description in connection with the drawings is intended principally as a description of the presently preferred embodiments of the invention and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A shock absorber, comprising:
a first tube having an interior and an exterior, the interior of the first tube at least partially defining a first chamber and wherein the first chamber is at least partially filled with a first at least one fluid and the exterior of the first tube being exposed to ambient air at atmospheric pressure;
a second tube configured to telescopically interfit with the first tube; and
a release valve adjacent a first passageway and configured to allow the first at least one fluid to move through the first passageway from the interior of the first tube to the exterior of the first tube when a pressure of the at least one fluid exceeds a release valve threshold, wherein the release valve includes:
a first spring;
a first blocker;
a first seat; and
a first spring adjuster configured to adjust the release valve threshold;
wherein the first spring urges the first blocker against the first seat to block movement of the first at least one fluid through the first passageway.

2. The shock absorber according to claim 1, wherein the first spring adjuster is adjustable from the exterior of the first tube.

3. The shock absorber according to claim 1, further comprising a fluid introduction valve adjacent a second passageway configured to allow a second at least one fluid to move through the second passageway from the exterior of the first tube to the interior of the first tube, wherein the fluid introduction valve includes a second spring, a second blocker, a second seat, wherein the second spring urges the second blocker against the second seat.

4. The shock absorber according to claim 3, further comprising a fluid introduction fixture configured to mate with the fluid introduction valve.

5. The shock absorber according to claim 4, wherein the fluid introduction fixture further comprises a reservoir.

6. The shock absorber according to claim 5, further comprising a pump attached to the reservoir.

7. The shock absorber according to claim 6, wherein the pump comprises a plunger configured to reciprocate in the reservoir and configured to be actuated by a user.

8. The shock absorber according to claim 3, wherein the second at least one fluid includes a substantially incompressible fluid.

9. The shock absorber according to claim 3, wherein the release valve and the fluid introduction valve are spaced from one another longitudinally along a length of the first tube.

10. The shock absorber according to claim 3, wherein the release valve and the fluid introduction valve are spaced from one another circumferentially about a circumference of the first tube.

11. A shock absorber, comprising:
a first tube having an interior and an exterior, the interior of the first tube at least partially defining a first chamber;
a second tube configured to telescopically interfit with the first tube;
a fluid introduction passageway extending between an interior port on the interior of the first tube and an exterior port on the exterior of the first tube;
a fluid introduction valve configured to allow the introduction of at least one fluid from the exterior of the first tube into the first chamber; and
a fluid retainer positioned adjacent the interior port, wherein the fluid retainer is configured to retain at least some of the at least one fluid introduced through the fluid introduction passageway.

12. The shock absorber according to claim 11, wherein the fluid retainer is a ring.

13. The shock absorber according to claim 11, wherein the fluid retainer is made from a foam.

14. The shock absorber according to claim 13, wherein the foam is an open-celled foam.

15. The shock absorber according to claim 11, wherein the fluid retainer is configured to retain at least 1 milliliter of the at least one fluid.

16. The shock absorber according to claim 11, wherein the fluid retainer has a first length and the interior port has a second length and the first length is greater than the second length.

17. The shock absorber according to claim 11, wherein the fluid introduction valve includes a spring, a blocker, and a seat, wherein the spring urges the blocker against the seat.

18. The shock absorber according to claim 11, further comprising a seal extending between the first tube and the second tube and wherein the fluid retainer is positioned adjacent the seal.

19. The shock absorber according to claim 18, wherein the interior port is positioned between the seal and the fluid retainer.

20. The shock absorber according to claim 11, wherein the at least one fluid comprises a substantially incompressible fluid.
